(19) United States
(12) Patent Application Publication
(10) Pub. No.: US 2018/0312421 A1
(43) Pub. Date: Nov. 1, 2018

(54) SYSTEMS AND METHODS FOR DISPLAY FORMATION USING A MECHANICALLY PRESSED PATTERN

(71) Applicant: Corning Incorporated, Corning, NY (US)

(72) Inventors: Sean Matthew Garner, Elmira, NY (US); Timothy James Kiczenski, Corning, NY (US); William Edward Lock, Househeads, NY (US); Thomas Matthew Sonner, Corning, NY (US)

(21) Appl. No.: 15/581,382

(22) Filed: Apr. 28, 2017

(51) Int. Cl. C03B 23/00; C03B 23/02

(52) U.S. Cl. CPC C03B 23/004; C03B 23/02

(57) ABSTRACT

Embodiments are related to scalable surface feature formation in a substrate and, more particularly, to systems and methods for forming displays using mechanically pressed patterns.

### FIELD OF THE INVENTION

Embodiments are related to scalable surface feature formation in a substrate and, more particularly, to systems and methods for forming displays using mechanically pressed patterns.

### BACKGROUND

LED displays, LED display components, and arrayed LED devices include a large number of diodes placed at defined locations across the surface of the display or device. Fluidic assembly may be used for assembling diodes in relation to a substrate. Such assembly is often a stochastic process whereby LED devices are deposited into wells on a substrate. Forming such wells into the surface of a substrate using traditional laser damage and etch processes are done one location at a time. As such forming several million wells in the surface of a substrate is prohibitively expensive.

Hence, for at least the aforementioned reasons, there exists a need in the art for advanced systems and methods for manufacturing physical structures on a substrate.

### SUMMARY

Embodiments are related to scalable surface feature formation in a substrate and, more particularly, to systems and methods for forming displays using mechanically pressed patterns.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Many other embodiments of the invention will become more fully apparent from the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIGS. 1a-1c show various views of a substrate formation system including a structure roller capable of forming openings in a substrate surface in accordance with some embodiments of the present inventions;

FIG. 2 is a flow diagram depicting a method in accordance with some embodiments of the present inventions for forming openings in the surface of a substrate;

FIG. 3 shows a cross-sectional view of another substrate formation system including a structure roller capable of forming openings in a substrate surface in accordance with various embodiments of the present inventions;

FIG. 4 is a flow diagram depicting another method in accordance with other embodiments of the present inventions for forming openings in the surface of a substrate;

FIG. 5 shows a cross-sectional view of yet another substrate formation system including a structure roller capable of forming openings in two surfaces of a substrate in accordance with one or more embodiments of the present inventions;

FIG. 6 is a flow diagram depicting yet another method in accordance with other embodiments of the present inventions for forming openings in two surfaces of a substrate; and

FIGS. 7a-7b depict a fluidic assembly system capable of moving a suspension composed of a carrier liquid and a plurality of physical objects relative to an embossed material layer atop a surface of a substrate in accordance with one or more embodiments of the present inventions.

### DETAILED DESCRIPTION OF SOME EMBODIMENTS

Embodiments are related to scalable surface feature formation in a substrate and, more particularly, to systems and methods for forming displays using mechanically pressed patterns.

Various embodiments provide continuous substrate formation systems. The systems include: a cooling roller by which a first heated glass material at a first temperature is pressed to yield a second heated glass material at a second temperature and a viscosity; and a structure roller by which the second heated glass material is pressed to form a pattern into the second heated glass material to yield a patterned glass substrate. The structure roller includes a rolling surface from which a plurality of structures extend, and the pattern in the patterned glass substrate corresponds to the plurality of structures.

In some instances of the aforementioned embodiments, the pattern in the patterned glass substrate includes a number of openings extending into the patterned glass substrate. As used herein, the term “openings” is used in its broadest sense to mean any depression that extends into a substrate without extending through the substrate into which it is formed. As one example, an opening may be a well that extends a defined depth into the substrate where the depth is less than the thickness of the substrate. As another example, an opening may be a trench or other structure that extends a defined depth into the substrate where the depth is less than the thickness of the substrate. Based upon the disclosure provided herein, one of ordinary skill in the art will recognize a variety of openings that may be formed in accordance with one or more embodiments of the present inventions. In some such instances, a maximum width of each of the number of openings is between one (1) and two hundred (200) micrometers, and wherein a maximum depth of each of the number of openings is between one half (0.5) and ten (10) micrometers. In other instances of the aforementioned embodiments, the plurality of structures includes a plurality of cylinder shaped structures extending from the rolling surface, and wherein the pattern in the patterned glass substrate includes a number of cylinder shaped openings extending into the patterned glass substrate. In some such instances, a diameter of the cylinder shaped openings is between one (1) and two hundred (200) micrometers, and wherein a depth of the cylinder shaped openings is between one half (0.5) and ten (10) micrometers.

In some cases, the first heated glass material is an alkali free material. In various cases, the first heated glass material is molten. In some cases, the viscosity is less than 500 kP. In particular cases, where the structure roller is a first structure roller, the systems may further include a second structure roller where the second heated glass material is pressed between the first structure roller and the second structure roller. In one or more cases, the systems further include a flat surface roller where the second heated glass material is pressed between the structure roller and the flat surface roller.

Other embodiments provide methods for forming a substrate. The methods include: continuously pressing a first heated glass material at a first temperature with a cooling roller to yield a second heated glass material at a second temperature and a viscosity; and continuously pressing the second heated glass material with a structure roller to form a pattern into the second heated glass material to yield a patterned glass substrate. The structure roller includes a rolling surface from which a plurality of structures extend, and the pattern in the patterned glass substrate corresponds to the plurality of structures. In some cases, the first heated glass material is an alkali free material. In various cases, the first heated glass material is molten. In some cases, the viscosity is less than 500 kP.

In some instances of the aforementioned embodiments, the pattern in the patterned glass substrate includes a number of openings extending into the patterned glass substrate. In such instances, the methods may further include: placing a display substrate derived from the patterned glass substrate into a fluidic assembly system; and moving a suspension of a micro-LEDs in a carrier fluid relative to a surface of the display substrate such that a subset of the micro-LEDs deposit into the number of openings.

In various instances of the aforementioned embodiments, the pattern in the patterned glass substrate includes a number of openings extending into the patterned glass substrate. In some such instances, a maximum width of each of the number of openings is between twenty (20) and eighty (80) micrometers, and wherein a maximum depth of each of the number of openings is between one half (0.5) and ten (10) micrometers. In other instances of the aforementioned embodiments, the plurality of structures includes a plurality of cylinder shaped structures extending from the rolling surface, and wherein the pattern in the patterned glass substrate includes a number of cylinder shaped openings extending into the patterned glass substrate. In some such instances, a diameter of the cylinder shaped openings is between one (1) and two hundred (200) micrometers, and wherein a depth of the cylinder shaped openings is between one half (0.5) and ten (10) micrometers.

In some instances of the aforementioned embodiments where the pattern in the patterned glass substrate includes a number of openings extending into the patterned glass substrate, the methods may further include forming through holes extending from a bottom of each of the number of openings.

Yet other embodiments provide a glass substrate. The glass substrate includes a glass material having a viscosity of less than five hundred (kP) and having a plurality of openings patterned into the surface of the glass material. The maximum width of each of the number of openings is between one (1) and two hundred (200) micrometers, and a maximum depth of each of the number of openings is between one half (0.5) and ten (10) micrometers.

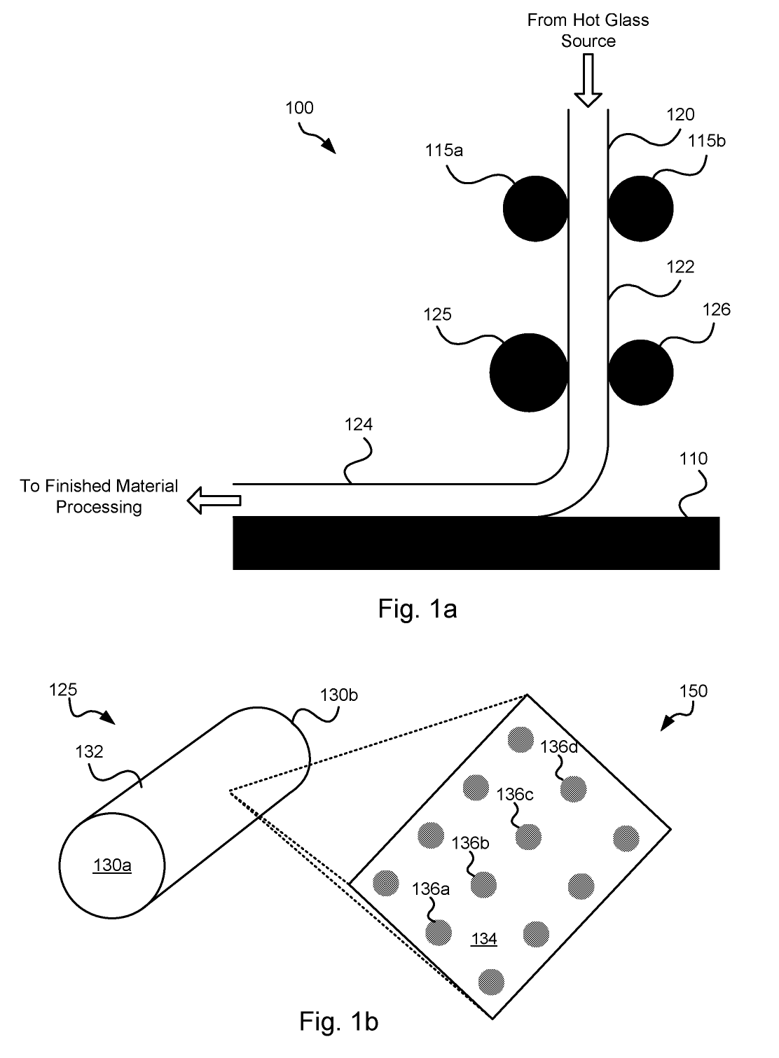

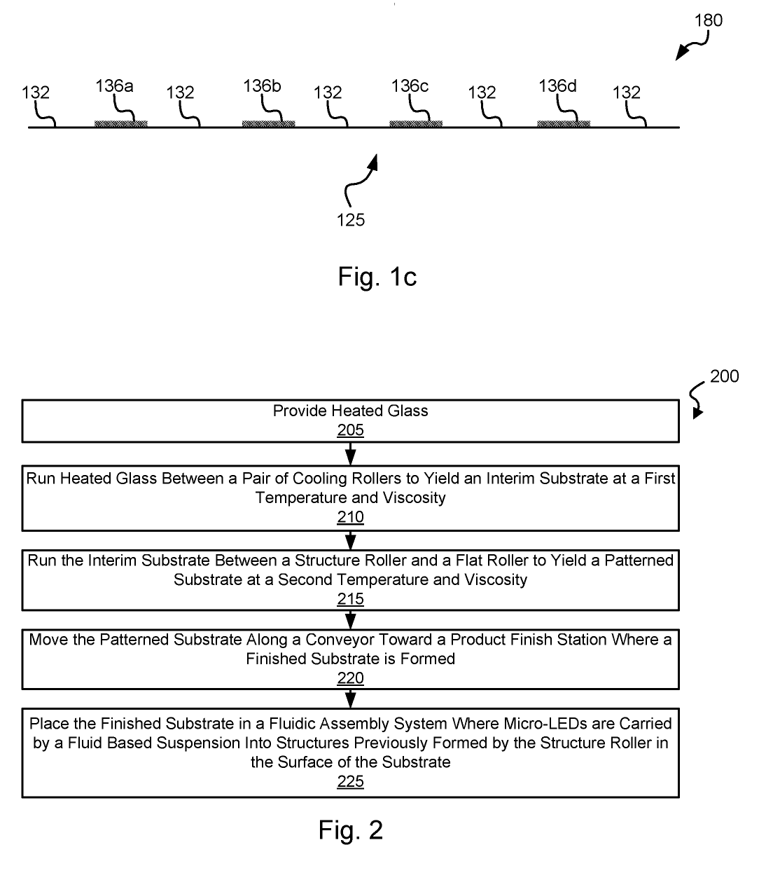

Turning to FIG. 1a, a substrate formation system 100 is shown including a structure roller 125 capable of forming openings in a substrate surface is depicted in accordance with some embodiments. As shown, a heated glass material 120 at a first temperature is received from a hot glass source (not shown) and is pressed between two opposing cooling rollers 115 resulting in a heated glass material 122 at a second temperature where the second temperature is less than the first temperature. In some cases, the first temperature is sufficiently high that heated glass material 120 is molten. Heated glass material 122 is then pressed between structure roller 125 and an opposing roller 126. The second temperature and corresponding viscosity are selected for the particular glass material being formed such that the material is sufficiently malleable to allow for forming an opening in heated glass material 122 without breaking and yet sufficiently stiff to assure that the pressed shape is retained. Alternatively, both roller 125 and roller 126 can have structures that result in surface patterns on each side of the glass. These features on each side of the glass can either be registered to each other or non-registered. Also, the features can be similar or have distinct difference in sizes, shapes, depths, and/or patterns.

Turning to FIG. 1b, a view 150 of structure roller 125 is shown. As shown, structure roller 125 is cylindrically shaped having circular ends 130 and a cylinder surface 132. A number of structures 136 are attached to extend away from cylinder surface 132. A portion 134 of cylinder surface 132 is shown including structures 136. Turning to FIG. 1c, a side view 180 of cylinder surface 132 is shown from which structures 136 extend. In some embodiments, the size and shape of structures 136 is designed to form wells into the surface of a glass substrate of a size to accept micro-diodes or micro-LEDs each forming part of an electronic display. As size that accepts a micro-diode is a size that is larger than the device that is to be accepted into the well after the hot substrate into which the well is formed has cooled. In other embodiments other feature shapes either in place of or in addition to wells may be formed of a size to accept either micro-diode or another type of electronic or optoelectronic or other type of solid structure. In one particular embodiment, where the wells are to have a diameter of fifty (50) micrometers and a depth of less than ten (10) micrometers, structures 136 are cylindrical in shape with a diameter of fifty (50) to sixty (60) micrometers and a height of ten (10) micrometers. Such a shape and size facilitates the formation of wells of the appropriate size and shape when heated glass material 122 is contacted by structure roller 125 as it is pressed between structure roller 125 and an opposing roller 126.

Pressing heated glass material 122 between structure roller 125 and an opposing roller 126 results in a patterned glass material 124 that is transitioned to a conveyor 110 where it is moved toward other processes that are applied to yield desired patterned glass substrates. It should be noted that the size and shape of structures 136 may be modified to provide a desired pattern on the surface of a glass substrate. Based upon the disclosure provided herein, one of ordinary skill in the art will recognize a variety of structure rollers that may be manufactured and/or used which include structures extending from the surface thereof with particular sizes and shapes. As examples, the structures can be surface channels or wells that have widths ranging from 1 to 200 um and depths of 0.5 to 10 um. The structures can also be arrayed or irregular patterns that cause a surface texturing with feature widths of 10 nm to 1 um and aspect ratios of 10:1 to 1:10. The cross sectional shapes can have sidewall angles that vary between 1 to 90 degrees, 40 to 90 degrees, 60 to 90 degrees, and 80 to 90 degrees. The wall angle on 1 side of the feature can be different from the other side due to effects of leading and trailing embossing edges or other processing conditions. The shapes can be circular, square, triangular, or other irregular shapes. These features can be created on 1 or both surfaces of the glass. In addition, the final resulting features in the glass can be formed in combination of this embossing process with other processes such as wet or plasma etching, laser processing, or physical patterning.

Substrate formation system 100 provides a system that can mechanically press large numbers of structures into the surface of a substrate using a continuous process. This continuous process may be performed at a rate that is sufficiently high to reduce the cost of manufacturing, for example, display substrates into which millions of micro-diodes, micro-LEDs, and/or other elements are to be assembled. In some cases, substrate formation system 100 operates at a rate of one foot per second of heated glass material 122 being pressed between structure roller 125 and an opposing roller 126 with heated glass material 122 exhibiting a viscosity below 500 kP. In such a case, openings having a range of depth between one half (0.5) micrometers and ten (10) micrometers in depth, diameters of between one (1) micrometer and two hundred (200) micrometers, and spacing between respective wells of six hundred (600) micrometers. In some cases, the glass material selected results in a finished substrate that is alkali free which is particularly beneficial where the final product is to be part of an active matrix display.

Turning to FIG. 2, a flow diagram 200 shows a method in accordance with some embodiments of the present inventions for forming openings or wells in the surface of a substrate. Following flow diagram 200, heated glass material is provided (block 205). This may be provided by any source known in the art that is capable of dispensing glass at temperatures sufficiently high to be patterned by mechanical pressure into a glass substrate. The heated glass is run between a pair of cooling rollers which yield an interim substrate (block 210). The cooling applied by the cooling rollers results in a desired temperature and viscosity of the interim substrate. This temperature and viscosity are selected such that the interim substrate can be mechanically pressed such that it retains a pattern extending from the surface of a pressing device without breaking or being otherwise damaged.

The interim substrate is run between a structure roller and a flat surface roller to yield a patterned substrate at a second temperature and viscosity (block 215). The second temperature may be lower than the first temperature where the combination of the structure roller and a flat surface roller is cooler than the first temperature, may be substantially the same as the first temperature, or may be higher than the first temperature where the combination of the structure roller and a flat surface roller is hotter than the first temperature. The rollers must be heated in the aforementioned condition where the combination of the structure roller and a flat surface roller is hotter than the first temperature. Moving the interim substrate between a structure roller on one side and a flat surface roller on the opposite side results in a pattern in one surface of the resulting patterned substrate. In particular cases, the structure roller may be similar to that discussed above in relation to FIGS. 1b-1c. The patterned substrate may include any type of patterning. In one particular embodiment, the patterning includes a number of openings or wells extending below the surface of the patterned substrate.

The resulting patterned substrate is moved along a conveyor toward a product finish station where a finished substrate is formed (block 220). Any number of processes may be performed to yield the finished substrate including, but not limited to, laminating the finished substrate to another substrate to yield a composite substrate and/or cutting the finished substrate to a desired dimension. Laminating the finished substrate to another substrate to yield a composite substrate is particularly useful where flat bottoms are desired in structures formed in the finished substrate. In such a scenario, running the interim substrate between the structure roller and the flat surface roller results in structures formed in the patterned substrate, and an etch process registered to the structures can extend the formed structures to yield holes through the substrate. By laminating the finished substrate having through holes to another substrate, the bottom of the through holes are flat like the top surface of the other substrate to which it is laminated. In addition, in some embodiments through holes are etched into the bottom of the wells formed by the mechanical pressing process using the structure roller. Such through holes may be made using a photo-lithography process that relies on the location of the wells for alignment. In some cases, the diameter of the through holes extending from the bottom of the wells is less than the diameter of the wells. In one particular case where the diameter of the wells is fifty (50) micrometers, the diameter of the through holes is less than twenty (20) micrometers.

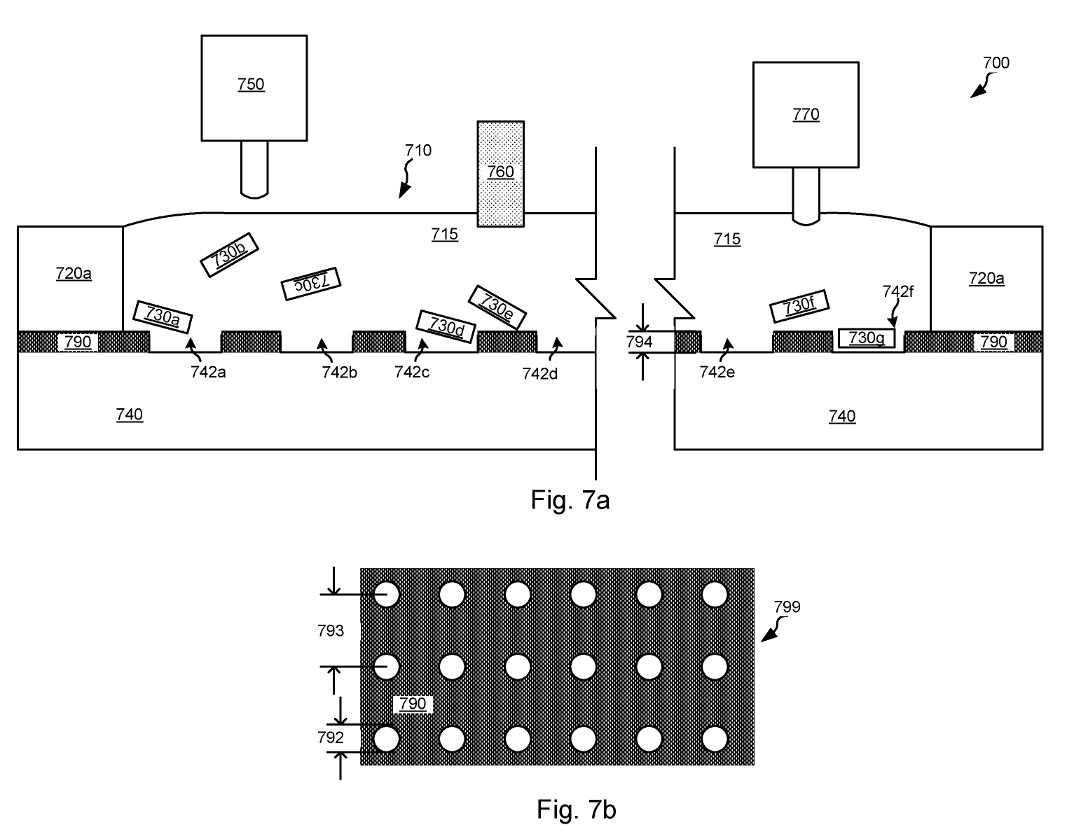

Next, the finished substrate is placed in a fluidic or other assembly system where micro-LEDs are carried by a fluid based suspension into structures formed by the structure roller in the surface of the finished substrate (block 225). This process may be done similar to that discussed below in relation to FIGS. 7a-7b.

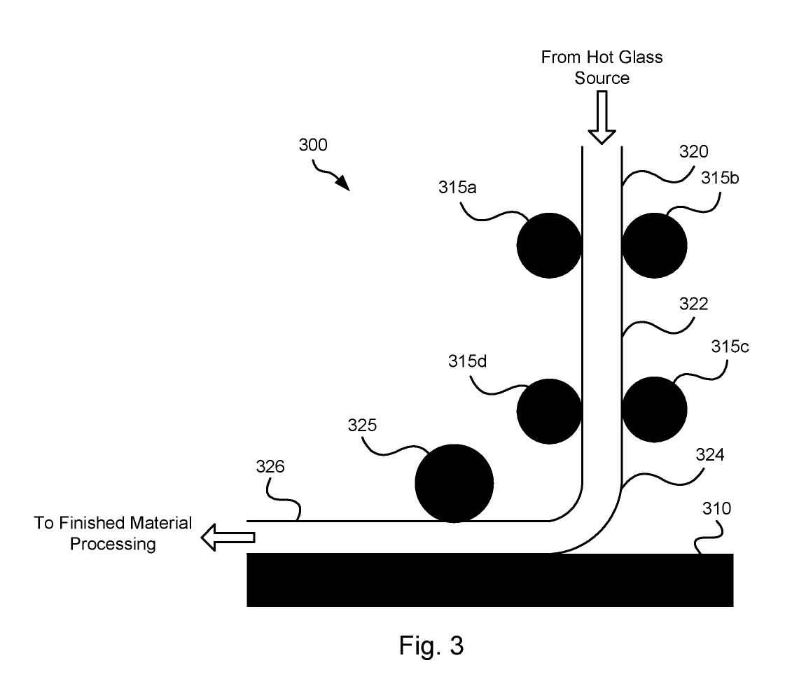

Turning to FIG. 3, a cross-sectional view of another substrate formation system 300 including a structure roller 325 capable of forming openings in a substrate surface is shown in accordance with some embodiments. As shown, a heated glass material 320 at a first temperature is received from a hot glass source (not shown) and is pressed between two opposing cooling rollers 315a, 315b resulting in a heated glass material 322 at a second temperature where the second temperature is less than the first temperature. In some cases, the first temperature is sufficiently high that heated glass material 320 is molten. Heated glass material 322 is then pressed between two opposing cooling rollers 315c, 315d resulting in a heated glass material 324 at a third temperature where the third temperature is less than the second temperature. Rollers 315 can also precision dimension the sheet thickness.

Heated glass material 324 is transitioned to a conveyor 310 where it is conveyed toward structure roller 325. Heated glass material 324 is pressed between structure roller 325 and conveyor 310 and emerges as a patterned glass material 326. The third temperature and corresponding viscosity are selected for the particular glass material being formed such that the material is sufficiently malleable to allow for forming an opening in heated glass material 324 without breaking and yet sufficiently stiff to assure that the pressed shape is retained. Structure roller 325 may be similar to that described above in relation to structure roller 125 of FIGS. 1a-1c. Patterned glass material 326 is moved along conveyor 310 toward other processes that are applied to yield desired patterned glass substrates.

Substrate formation system 300 provides a system that can mechanically press large numbers of structures into the surface of a substrate using a continuous process. This continuous process may be performed at a rate that is sufficiently high to reduce the cost of manufacturing, for example, display substrates into which millions of micro-diodes, micro-LEDs, or other elements are to be assembled. In some cases, substrate formation system 300 operates at a rate of one foot per second of heated glass material 324 being pressed between structure roller 325 and conveyor 310 with heated glass material 324 exhibiting a viscosity below 500 kP. In such a case, openings having a range of depth between one half (0.5) micrometers and ten (10) micrometers in depth, diameters of between one (1) micrometer and two hundred (200) micrometers, and spacing between respective wells of six hundred (600) micrometers. In some cases, the glass material selected results in a finished substrate that is alkali free which is particularly beneficial where the final product is to be part of an active matrix display.

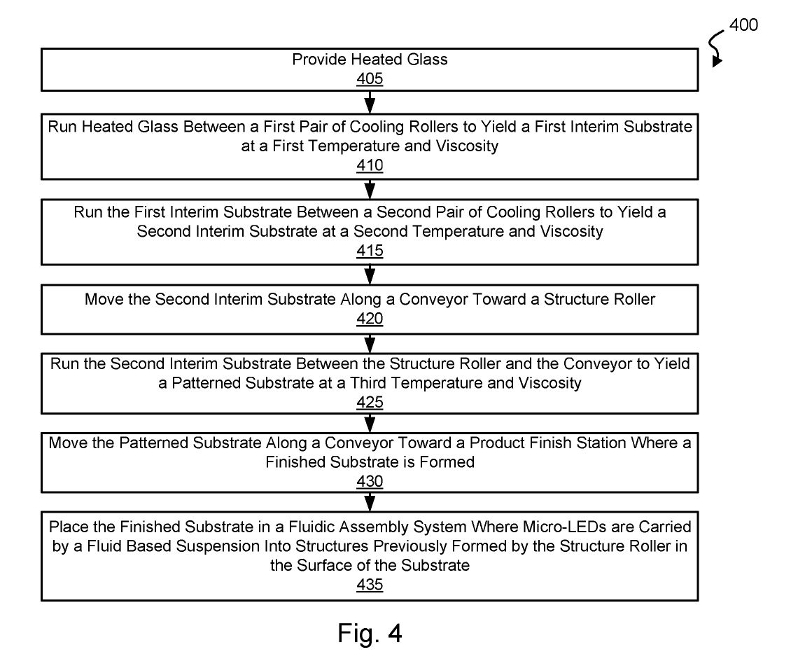

Turning to FIG. 4, a flow diagram 400 depicts another method in accordance with other embodiments of the present inventions for forming openings or wells in the surface of a substrate. Following flow diagram 400, heated glass material is provided (block 405). This may be provided by any source known in the art that is capable of dispensing glass at temperatures sufficiently high to be patterned by mechanical pressure into a glass substrate. The heated glass is run between a pair of cooling rollers which yield a first interim substrate (block 410). The cooling applied by the cooling rollers results in a desired first temperature and first viscosity of the interim substrate. The first interim substrate is run between another pair of cooling rollers which yield a second interim substrate (block 415). The cooling applied by these additional cooling rollers results in a desired second temperature and second viscosity of the interim substrate. This second temperature and second viscosity are selected such that the second interim substrate can be mechanically pressed such that it retains a pattern extending from the surface of a pressing device without breaking or being otherwise damaged.

The second interim substrate is transitioned to a conveyor where it is moved along toward a structure roller (block 420). As the second interim substrate is pressed between the structure roller and the conveyor a patterned substrate results at a third temperature and third viscosity (block 425). The third temperature may be lower than the second temperature where the combination of the structure roller and the conveyor is cooler than the second temperature, may be substantially the same as the second temperature, or may be higher than the second temperature where the combination of the structure roller and the conveyor is hotter than the second temperature. The rollers must be heated in the aforementioned condition where the combination of the structure roller and a flat surface roller is hotter than the second temperature. Moving the second interim substrate between a structure roller on one side and a flat conveyor surface on the opposite side results in a pattern in one surface of the resulting patterned substrate. In some embodiments, the flat surface of the conveyor may be replaced by another structure roller resulting in patterning of both surfaces of the patterned substrate. In particular cases, the structure roller may be similar to that discussed above in relation to FIGS. 1b-1c. Also, the flat surface of the conveyor may be replaced by flat patterned plates so that both sides of the substrate are patterned.

The resulting patterned substrate is moved along a conveyor toward a product finish station where a finished substrate is formed (block 430). Any number of processes may be performed to yield the finished substrate including, but not limited to, laminating the finished substrate to another substrate to yield a composite substrate and/or cutting the finished substrate to a desired dimension. Laminating the finished substrate to another substrate to yield a composite substrate is particularly useful where flat bottoms are desired in structures formed in the finished substrate. In addition, in some embodiments through holes are etched into the bottom of the wells formed by the mechanical pressing process using the structure roller. Such through holes may be made using a photo-lithography process that relies on the location of the wells for alignment. In some cases, the diameter of the through holes extending from the bottom of the wells is less than the diameter of the wells. By laminating the finished substrate having through holes to another substrate, the bottom of the through holes are flat like the top surface of the other substrate to which it is laminated. In one particular case where the diameter of the wells is fifty (50) micrometers, the diameter of the through holes is less than twenty (20) micrometers.

Next, the finished substrate is placed in a fluidic or other assembly system where micro-LEDs or other elements are carried by a fluid based suspension into structures formed by the structure roller in the surface of the finished substrate (block 435). Other assembly methods include processes such as pick-and-place. Also, a combination of fluidic and pick-and-place assembly methods can be used. This process may be done similar to that discussed below in relation to FIGS. 7a-7b.

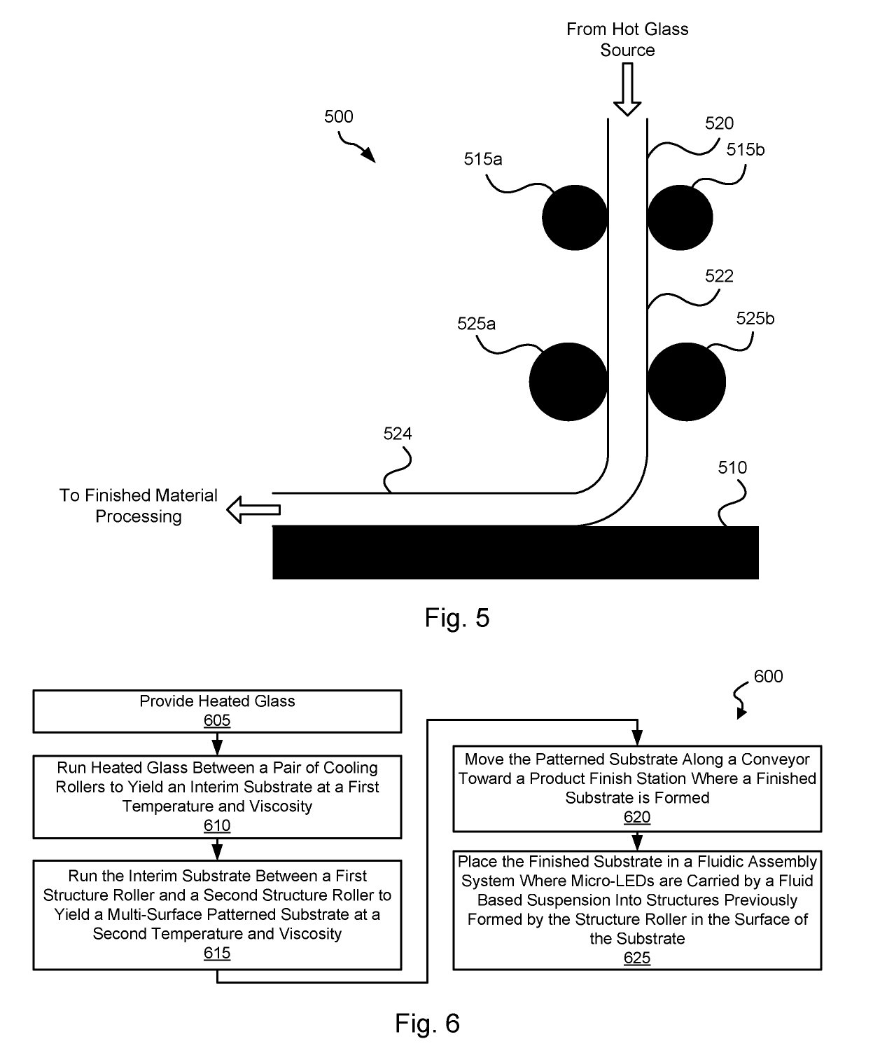

Turning to FIG. 5, a cross-sectional view of yet another substrate formation system 500 including dual structure rollers 525a, 525b capable of forming openings in a substrate surface in accordance with some embodiments. As shown, a heated glass material 520 at a first temperature is received from a hot glass source (not shown) and is pressed between two opposing cooling rollers 515 resulting in a heated glass material 522 at a second temperature where the second temperature is less than the first temperature. In some cases, the first temperature is sufficiently high that heated glass material 520 is molten. Heated glass material 522 is then pressed between structure roller 525a and structure roller 525b. The second temperature and corresponding viscosity are selected for the particular glass material being formed such that the material is sufficiently malleable to allow for forming an opening in heated glass material 522 without breaking and yet sufficiently stiff to assure that the pressed shape is retained. Each of structure roller 525a and structure roller 525b may be similar to that described above in relation to structure roller 125 of FIGS. 1a-1c. Pressing heated glass material 522 between structure roller 525a and structure roller 525b results in a patterned glass material 524 that is transitioned to a conveyor 510 where it is moved toward other processes that are applied to yield desired patterned glass substrates. Structure rollers 525a, 525b can be synchronized such that a pattern formed on one side of the substrate is registered to a pattern formed on the other side of the substrate. The patterns formed on the opposing sides of the substrate may either be matching or distinctly different.

Substrate formation system 500 provides a system that can mechanically press large numbers of structures into two surfaces of a substrate using a continuous process. This continuous process may be performed at a rate that is sufficiently high to reduce the cost of manufacturing, for example, display substrates into which millions of micro-diodes or micro-LEDs are to be assembled. In some cases, substrate formation system 500 operates at a rate of one foot per second of heated glass material 522 being pressed between structure roller 525a and structure roller 525b with heated glass material 522 exhibiting a viscosity below 500 kP. In such a case, openings having a range of depth between one half (0.5) micrometers and ten (10) micrometers in depth, diameters of between one (1) micrometer and two hundred (200) micrometers, and spacing between respective wells of six hundred (600) micrometers. In some cases, the glass material selected results in a finished substrate that is alkali free which is particular beneficial where the final product is to be part of an active matrix display.

Turning to FIG. 6, a flow diagram 600 shows a method in accordance with some embodiments of the present inventions for forming openings or wells in two surfaces of a substrate. Following flow diagram 600, heated glass material is provided (block 605). This may be provided by any source known in the art that is capable of dispensing glass at temperatures sufficiently high to be patterned by mechanical pressure into a glass substrate. The heated glass is run between a pair of cooling rollers which yield an interim substrate (block 610). The cooling applied by the cooling rollers results in a desired temperature and viscosity of the interim substrate. This temperature and viscosity are selected such that the interim substrate can be mechanically pressed such that it retains a pattern extending from the surface of a pressing device without breaking or being otherwise damaged.

The interim substrate is run between a first structure roller and a second structure roller to yield a multi-surface patterned substrate at a second temperature and viscosity (block 615). The second temperature may be lower than the first temperature where the combination of the first structure roller and a second structure roller is cooler than the first temperature, may be substantially the same as the first temperature, or may be higher than the first temperature where the combination of the structure rollers is hotter than the first temperature. The first structure roller and a second structure roller must be heated in the aforementioned condition where the combination of the two structure rollers is hotter than the first temperature. Moving the interim substrate between the opposing structure rollers results in a pattern in two surfaces of the resulting patterned substrate. In particular cases, the structure rollers may each be similar to that discussed above in relation to FIGS. 1b-1c.

The resulting patterned substrate is moved along a conveyor toward a product finish station where a finished substrate is formed (block 620). Any number of processes may be performed to yield the finished substrate including, but not limited to, cutting the finished substrate to a desired dimension. In addition, in some embodiments through holes are etched into the bottom of the wells formed by the mechanical pressing process using the structure roller. Such through holes may be made using a photo-lithography process that relies on the location of the wells for alignment. In some cases, the diameter of the through holes extending from the bottom of the wells is less than the diameter of the wells. In one particular case where the diameter of the wells is fifty (50) micrometers, the diameter of the through holes is less than twenty (20) micrometers. Next, the finished substrate is placed in a fluidic or other assembly system where micro-LEDs or other elements are carried by a fluid based suspension into structures formed by the structure roller in the surface of the finished substrate (block 625). This process may be done similar to that discussed below in relation to FIGS. 7a-7b.

Turning to FIG. 7a, a fluidic assembly system 700 is shown that is capable of moving a suspension 710 composed of a carrier liquid 715 and a plurality of physical objects 730 relative to an embossed material layer 790 atop a surface of a substrate 740 in accordance with one or more embodiments of the present inventions. As used herein, the phrase “embossed material layer” is used in its broadest sense to mean any layer wherein structures are pressed into the surface of a material. In some embodiments, substrate 740 is a glass substrate that has the same properties as embossed material layer 790. In other embodiments, embossed material layer 790 formed of one material is laminated to substrate 740 that is formed of another material. In some cases, the combination of substrate 740 and embossed material layer 790 may be rigid, and in other cases the combination may be flexible. The overall substrate including the embossed layer may be a single or multi-layer stack. These layers can be made of materials including glass, ceramic, glass-ceramic, and metal.

In some cases, physical objects 730 may be micro-diodes or micro-LEDs, however, in other cases the physical objects may be other electronic devices or non-electronic devices. Turning to FIG. 7b, an example top view 799 of the surface of substrate 740 is shown with an array of wells (shown as circles) extending into embossed material layer 790. Each of wells 742 has a diameter 792 and a depth 794. It should be noted that while wells 742 are shown as circular in cross-section that other shapes may be used in relation to different embodiments. In some embodiments, substrate 740 is a glass substrate and diameter 792 is sixty (60) micrometers or less formed in embossed material layer 790 at five hundred (500) micrometers offsets 793 or less. Depth 794 is less than ten (10) micrometers. In some embodiments embossed material layer 790 is formed into substrate 740 by pressing a structure pattern corresponding to wells 742 into the surface of substrate 740 It should be noted that while in some embodiments the bottom of wells are formed of a portion of a top surface of substrate 740 where through holes are formed in embossed material layer 790, in other embodiments substrate 740 and embossed material layer 790 are a single layer of material into which wells 742 are defined that extend only part way through the layer of material.

In some cases, the thickness of embossed material layer 790 is substantially equal to the height of physical objects 730 where the aforementioned pressing of wells into the surface of embossed material layer 790 results in openings that extend to a top surface of substrate 740 which is laminated to embossed material layer 790. In other cases, the thickness of embossed material layer 790 is greater than the thickness of physical objects 730 where wells 742 are to be formed entirely within embossed material layer 790 where the material of substrate 740 and that of embossed material layer 790 are the same. In other cases, the thickness of embossed material layer 790 is less than that of the physical objects 730. An inlet opening of wells 742 is greater that the width of physical objects 730 such that only one physical object 730 deposits into any given well 742. It should be noted that while embodiments discuss depositing physical objects 730 into wells 742, that other devices or objects may be deposited in accordance with different embodiments of the present inventions.

A depositing device 750 deposits suspension 710 over the surface of substrate 740 with suspension 710 held on top of substrate 740 by sides 720 of a dam structure. In some embodiments, depositing device 750 is a pump with access to a reservoir of suspension 710. A suspension movement device 760 agitates suspension 710 deposited on substrate 740 such that physical objects 730 move relative to the surface of substrate 740. As physical objects 730 move relative to the surface of substrate 740 they deposit into wells 742. In some embodiments, suspension movement device 760 is a brush that moves in three dimensions. Based upon the disclosure provided herein, one of ordinary skill in the art will recognize a variety of devices that may be used to perform the function of suspension movement device 760 including, but not limited to, a pump.

A capture device 770 includes an inlet extending into suspension 710 and capable of recovering a portion of suspension 710 including a portion of carrier liquid 715 and non-deposited physical objects 730, and returning the recovered material for reuse. In some embodiments, capture device 770 is a pump. In some cases, substrate 740 including embossed material layer 790 is formed using one or more of the processes and/or systems discussed above in relation to FIGS. 1-6.

The combination of substrate 740 and embossed material layer 790 may exhibit not only physical features such as wells 742 shown in fluidic assembly system 700, but also can be chosen or formed to exhibit specific optical properties. For example, in terms of optical properties, the combination of substrate 740 and embossed material layer 790 can remain substantially transparent, have regions of being opaque to block or isolate light, or have regions of controlled optical scattering. Patterning of the combination of substrate 740 and embossed material layer 790 may occur on only a top surface as shown in fluidic assembly system 700, or on both a top and bottom surface.

In conclusion, the invention provides novel systems, devices, methods and arrangements for forming structures on a substrate. While detailed descriptions of one or more embodiments of the invention have been given above, various alternatives, modifications, and equivalents will be apparent to those skilled in the art without varying from the spirit of the invention. For example, while some embodiments are discussed in relation to forming and/or using wells or other structures for use in relation to fluidic assembly, it is noted that the embodiments find applicability to other structures including, but not limited to, surface roughening, fluidic steering features and/or other fluidic assembly features. Therefore, the above description should not be taken as limiting the scope of the invention, which is defined by the appended claims.

What is claimed is:

1. A continuous substrate formation system, the system comprising:
a cooling roller by which a first heated glass material at a first temperature is pressed to yield a second heated glass material at a second temperature and a viscosity; and
a structure roller by which the second heated glass material is pressed to form a pattern into the second heated glass material to yield a patterned glass substrate, wherein the structure roller includes a rolling surface from which a plurality of structures extend, and wherein the pattern in the patterned glass substrate corresponds to the plurality of structures.

2. The system of claim 1, wherein the pattern in the patterned glass substrate includes a number of openings extending into the patterned glass substrate.

3. The system of claim 2, wherein a maximum width of each of the number of openings is between one (1) and two hundred (200) micrometers, and wherein a maximum depth of each of the number of openings is between one half (0.5) and ten (10) micrometers.

4. The system of claim 1, wherein the plurality of structures includes a plurality of cylinder shaped structures extending from the rolling surface, and wherein the pattern in the patterned glass substrate includes a number of cylinder shaped openings extending into the patterned glass substrate.

5. The system of claim 4, wherein a diameter of the cylinder shaped openings is between one (1) and two hundred (200) micrometers, and wherein a depth of the cylinder shaped openings is between one half (0.5) and ten (10) micrometers.

6. The system of claim 1, wherein the first heated glass material is an alkali free material.

7. The system of claim 1, wherein the first heated glass material is molten.

8. The system of claim 1, wherein the viscosity is less than 500 kP.

9. The system of claim 1, wherein the structure roller is a first structure roller, the system further comprising:
a second structure roller, wherein the second heated glass material is pressed between the first structure roller and the second structure roller.

10. The system of claim 1, the system further comprising:
a flat surface conveyor, wherein the second heated glass material is pressed between the structure roller and the flat surface conveyor.

11. A method for forming a substrate, the method comprising:
continuously pressing a first heated glass material at a first temperature with a cooling roller to yield a second heated glass material at a second temperature and a viscosity; and
continuously pressing the second heated glass material with a structure roller to form a pattern into the second heated glass material to yield a patterned glass substrate, wherein the structure roller includes a rolling surface from which a plurality of structures extend, and wherein the pattern in the patterned glass substrate corresponds to the plurality of structures.

12. The method of claim 11, wherein the pattern in the patterned glass substrate includes a number of openings extending into the patterned glass substrate, the method further comprising:
placing a display substrate derived from the patterned glass substrate into a fluidic assembly system; and
moving a suspension of a micro-LEDs in a carrier fluid relative to a surface of the display substrate such that a subset of the micro-LEDs deposit into the number of openings.

13. The method of claim 11, wherein the pattern in the patterned glass substrate includes a number of openings extending into the patterned glass substrate, and wherein a maximum width of each of the number of openings is between one (1) and two hundred (200) micrometers, and wherein a maximum depth of each of the number of openings is between one half (0.5) and ten (10) micrometers.

14. The method of claim 11,wherein the plurality of structures includes a plurality of cylinder shaped structures extending from the rolling surface, and wherein the pattern in the patterned glass substrate includes a number of cylinder shaped openings extending into the patterned glass substrate.

15. The method of claim 14, wherein a diameter of the cylinder shaped openings is between one (1) and two hundred (200) micrometers, and wherein a depth of the cylinder shaped openings is between one half (0.5) and ten (10) micrometers.

16. The method of claim 11, wherein the first heated glass material is an alkali free material.

17. The method of claim 11, wherein the first heated glass material is molten.

18. The method of claim 11, wherein the viscosity is less than 500 kP.

19. The method of claim 11, wherein the pattern in the patterned glass substrate includes a number of openings extending into the patterned glass substrate, the method further comprising:
forming through holes extending from a bottom of each of the number of openings.

20. A glass substrate, the substrate comprising:
a glass material having a viscosity of less than five hundred (kP) and having a plurality of openings patterned into the surface of the glass material; and
wherein a maximum width of each of the number of openings is between twenty (20) and eighty (80) micrometers, and wherein a maximum depth of each of the number of openings is between one half (0.5) and ten (10) micrometers.
